(19) United States
(12) Patent Application Publication
(10) Pub. No.: US 2021/0406226 A1
(43) Pub. Date: Dec. 30, 2021

(54) System Building Assisting Apparatus and System Building Assisting Method

(71) Applicant: Hitachi, Ltd., Tokyo (JP)

(72) Inventors: Eiji NISHIJIMA, Tokyo (JP); Masafumi OKADA, Tokyo (JP); Natsuhiko INAKI, Tokyo (JP)

(21) Appl. No.: 17/345,552

(22) Filed: Jun. 11, 2021

(30) Foreign Application Priority Data
Jun. 26, 2020 (JP) 2020-110370

(51) Int. Cl. G06F 16/21; G06F 16/28; G06F 16/25; G06F 11/34

(52) U.S. Cl. CPC G06F 16/211; G06F 16/285; G06F 11/3438; G06F 16/256; G06F 16/258

(57) ABSTRACT

At present, on the basis of microservice, capabilities and applications of a monolithic integrated system are transitioned to a component system and rebuilt. However, the application of microservice to a shared database has not sufficiently been under study. A system building assisting apparatus of the present invention uses, in building of a component system, access history aggregation table indicating access history of access to a database for a production control system corresponding to an integrated system to be analyzed, to classify data items constituting the database as “individual data” or “common data.” At this time, the system building assisting apparatus desirably uses a capability corresponding to an access source indicated by the access history to classify each of the data items as “individual data” or “common data.”

### CLAIM OF PRIORITY

The present application claims priority from Japanese Patent Application JP 2020-110370 filed on Jun. 26, 2020, the content of which are hereby incorporated by references into this application.

### BACKGROUND OF THE INVENTION

### 1. Field of the Invention

The present invention relates to a technique for assisting building of a system including a plurality of capabilities, the building being performed by analyzing the system and including transition to and rebuilding of a new architecture.

### 2. Description of the Related Art

In the related art, a plurality of capabilities and services, in other words, many capabilities and services are implemented in a business system or the like (hereinafter referred to as a “system”) , and the system is configured to execute a capability or a service selected, according to an operation of a user or the like. A so-called “monolithic” architecture is used to build a system (hereinafter referred to as an “integrated system”).

In contrast, a system (hereinafter referred to as a component system) has been proposed that has an architecture in which a monolithic system is divided into optional capabilities of the monolithic system on the basis of a microservice architecture, containerization, cloud computing, or the like.

In building of such a component system, the capabilities of an integrated system such as a well-known integrated system are often transitioned. As a technique for the transition, a technique described in JP-2019-91415-A has been proposed.

To facilitate arrangement of an application generated in a cloud environment, JP-2019-91415-A discloses “a program enabled to be executed by an information processing apparatus generating the application, the program causing the information processing apparatus to function as definition information acquisition means for acquiring definition information used to generate the application, generation means for generating the application on the basis of the definition information acquired by the definition information acquisition means, connection information acquisition means for acquiring connection information used for connection to the cloud environment, history information acquisition means for acquiring history information related to the application, and arrangement means for connecting to the cloud environment using the connection information acquired by the connection information acquisition means and arranging the application generated by the generation means in the cloud environment on the basis of the history information related to the application and acquired by the history information acquisition means.”

In this regard, in the integrated system, a database for execution of the capabilities and services is shared among the capabilities. In contrast, for the component system, a reduction in the scale of the database is also desired, such as by provision of individual databases.

However, JP-2019-91415-A takes into account the preparation of a cloud environment according to the capabilities and applications of the component system but does not take into consideration rearrangement of databases, in other words, preparation of databases according to the capabilities. In other words, in JP-2019-91415-A, a “virtual database server 18” “that is utilized by an application generated” is only prepared in the cloud environment. Accordingly, in JP-2019-91415-A, a large-scale database shared among the capabilities needs to be prepared in every case.

It is thus an object of the present invention to assist building of a component system including transition to and rebuilding of the component system and also taking databases into account.

### SUMMARY OF THE INVENTION

To achieve this object, “access history information” for a database in an integrated system to be analyzed is used in building of component systems to classify data items constituting the database as “individual data” or “common data.” At this time, a capability corresponding to an access source indicated by “access history” is desirably used to classify each of the data items as “individual data” or “common data.”

A more specific aspect of the present invention includes a system building assisting apparatus for building a component system on the basis of an integrated system including a plurality of capabilities and a shared database shared by the plurality of capabilities and including a plurality of data items, the system building assisting apparatus including a storage apparatus storing access history information indicating that any of the data items constituting the shared database has been accessed by an access source capability of the integrated system, the access history information associating the access source capability and the data item corresponding to an access destination, and a processing section searching the access history information using a first capability name identifying a first capability included in the component system, to identify a data item for which the first capability corresponds to an access source, using the access history information to determine whether the data item identified has been accessed by a second capability included in the plurality of capabilities, and in a case of determining that the data item has not been accessed by the second capability, determining that the data item identified is individual data for the first capability.

Moreover, the present invention includes a system building assisting method using the system building assisting apparatus, a computer program causing the system building assisting apparatus to function as a computer, and a storage medium storing the computer program.

According to the aspect of the present invention, system building can be assisted that enables a database to be built according to applications and capabilities of a system to be built.

### BRIEF DESCRIPTION OF THE DRAWINGS

FIG. 1 is a diagram illustrating a concept of an embodiment of the present invention;

FIGS. 2A and 2B are a system configuration diagram in an embodiment of the present invention;

FIGS. 3A and 3B are a diagram for describing generation of various types of history information in an embodiment of the present invention;

FIG. 4 is a flowchart illustrating overall processing of a system building assisting apparatus in an embodiment of the present invention;

FIG. 5 is a diagram illustrating an access history aggregation table used in an embodiment of the present invention;

FIG. 6 is a diagram illustrating a display screen of an access source list in an embodiment of the present invention;

FIG. 7 is a flowchart illustrating a first example in the details of step S4 in an embodiment of the present invention;

FIG. 8 is a flowchart illustrating a second example in the details of step S4 in an embodiment of the present invention;

FIG. 9 is a diagram illustrating a classification result table used in an embodiment of the present invention;

FIG. 10 is a diagram illustrating a display screen displaying, in a list, classification results in an embodiment of the present invention; and

FIG. 11 is a diagram illustrating a display screen for graphical display in an embodiment of the present invention.

### DESCRIPTION OF THE PREFERRED EMBODIMENT

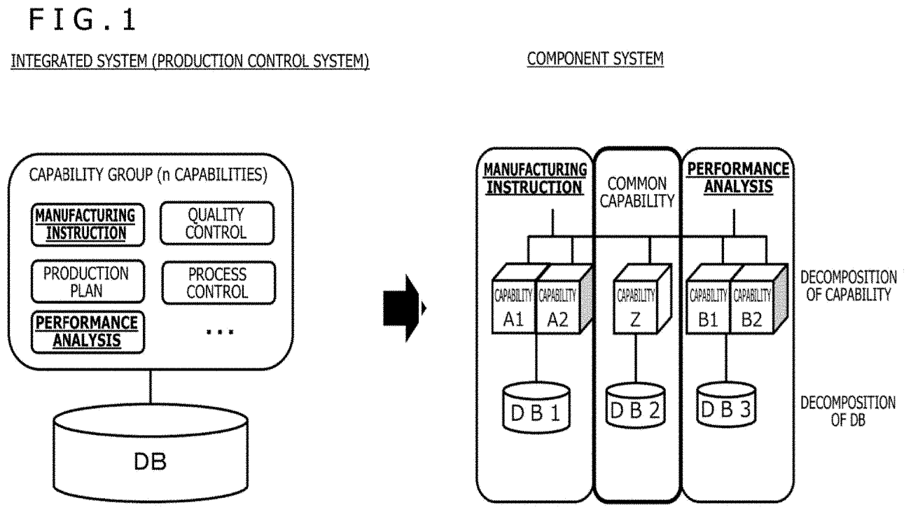

An embodiment of the present invention will be described using the drawings. First, FIG. 1 illustrates a concept of the present embodiment. In an integrated system, a group of n capabilities are configured as one system. For example, a production control system is configured as one integrated system including the group of n capabilities such as “manufacture instruction,” “quality control,” “production plan,” “process control,” and “performance analysis.” Additionally, in the integrated system, the group of n capabilities shares one database (DB) . In other words, the production control system illustrated in FIG. 1 includes a shared database accessible to the capabilities.

In contrast, in the present embodiment, optional capabilities are clipped from the integrated system, in other words, the integrated system is decomposed into the capabilities to build a component system. In the example illustrated in FIG. 1, the capabilities “manufacture instruction” and “performance analysis” are separated from the integrated system. Additionally, in building of the component system, a common capability is desirably provided that is common to at least two of the n capabilities . In the component system, the capabilities are, for example, sparsely coupled together.

In this regard, the component system is configured by separating the capabilities of the integrated system from one another. However, the database also needs to be decomposed. As illustrated in the example in FIG. 1, the database also needs to be decomposed such that “manufacture instruction” is associated with DB1 (individual database), “common capability” is associated with DB2 (common database), and “performance analysis” is associated with DB3 (individual database). In other words, each of the data items constituting the shared database needs to be classified as common data used by the capabilities or individual data specific to a particular capability. Thus, the present embodiment proposes a configuration in which, when the component system corresponding to the integrated system is built, the shared database is decomposed into different databases for the component system, and in particular, each data item is classified as common data or individual data. Note that in the present embodiment, a production control system and the capabilities of the production control system will be described as an example as described above but that the application of the present embodiment is not limited to the production control system and the capabilities of the production control system. Additionally, a building technique for the component system is not particularly limited but may be based on a so-called microservice, containerization, cloud computing, or the like.

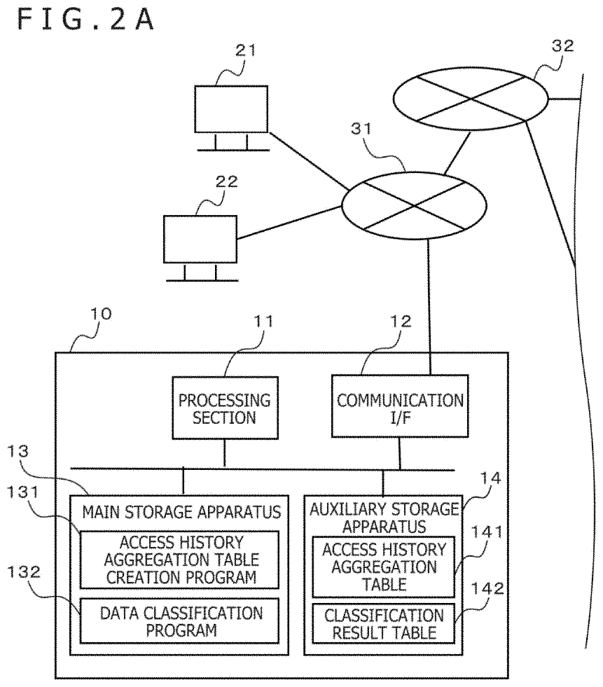

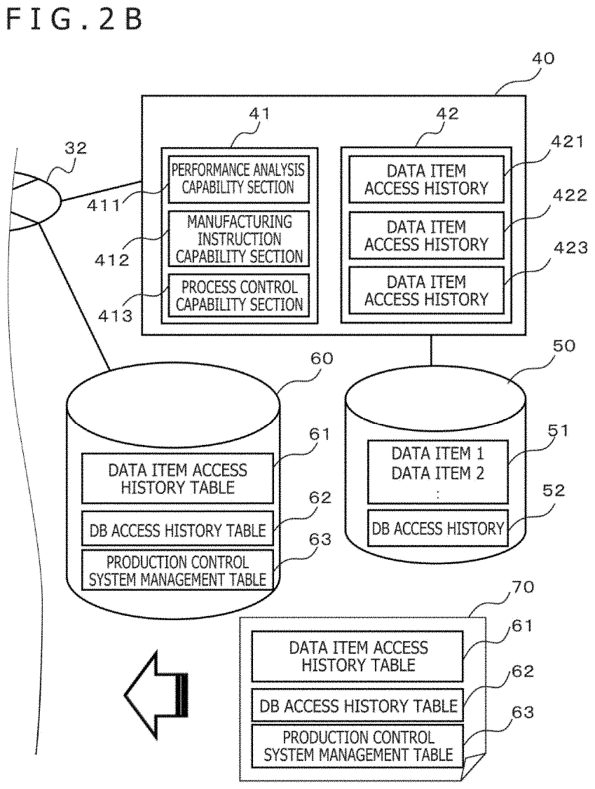

FIGS. 2A and 2B illustrate a system configuration diagram in the present embodiment. The system configuration in the present embodiment includes a system building assisting apparatus 10 executing main processing of the present embodiment, and a terminal apparatus 21 and a terminal apparatus 22 connected to the system building assisting apparatus 10 via a network 31. The terminal apparatuses 21 and 22 transmit, to the system building assisting apparatus 10, instructions input from a user, and receive processing results from the system building assisting apparatus 10. The terminal apparatuses 21 and 22 are implemented by so-called computers and can be implemented by laptop PCs (notebook PCs) or tablet computers, smartphones, or the like. Note that in the present embodiment, the terminal apparatuses 21 and 22 are provided but that an input capability and an output capability may be provided in the system building assisting apparatus 10, with the terminal apparatuses 21 and 22 omitted.

Now, a configuration of the system building assisting apparatus 10 will be described. The system building assisting apparatus 10 can be implemented by a so-called computer such as a server and includes a processing section 11, a communication interface (I/F) 12, a main storage apparatus 13, and an auxiliary storage apparatus 14. These components are connected together via a communication channel such as a bus.

Additionally, the processing section 11 can be implemented by a computing apparatus such as a CPU which executes various types of computing and processing. The processing section 11 also executes the computing and processing, according to programs stored in the main storage apparatus 13.

Additionally, the communication I/F 12 is connected to the network 31 to perform transmission to and reception from other apparatuses. Furthermore, the main storage apparatus 13 can be implemented by a so-called memory, and stores an access history aggregation table creation program 131 and a data classification program 132. The auxiliary storage apparatus 14 can be implemented by an HDD or an SSD and stores an access history aggregation table 141 and a classification result table 142.

Note that in the present embodiment, the auxiliary storage apparatus 14 is provided inside the system building assisting apparatus 10 but may be provided outside the system building assisting apparatus 10. For example, the auxiliary storage apparatus 14 may be configured as a file system connected to the network 31 and configured to be accessible from the terminal apparatuses 21 and 22. The access history aggregation table creation program 131 and the data classification program 132, and the access history aggregation table 141 and the classification result table 142 will be described below.

Additionally, the network 32 is desirably implemented by an intranet of a company or the like that operates the system building assisting apparatus 10.

FIGS. 2A and 2B illustrate a production control system 40 built as an integrated system and a database 50 used by the production control system 40. The production control system 40 is built as a monolithic system. In other words, the production control system 40 includes a capability section 41 executing a plurality of capabilities. The capability section 41 includes a performance analysis capability section 411, a manufacture instruction capability section 412, and a process control capability section 413. The production control system 40 can also be implemented as a computer, and the capability sections execute the corresponding capabilities, according to programs. Note that the present embodiment refers to the performance analysis capability section 411, the manufacture instruction capability section 412, and the process control capability section 413 but is not limited to these capability sections. Furthermore, the database 50 corresponds to the shared database described in FIG. 1.

Additionally, the production control system 40 includes a storage section 42 storing a data item access history 421, a data item access history 422, and a data item access history 423. The data item access histories are information indicating the history of access to the database 50 for each capability section. In the present embodiment, the history of the performance analysis capability section 411 is the data item access history 421, the history of the manufacture instruction capability section 412 is the data item access history 422, and the history of the process control capability section 413 is the data item access history 423. The data item access histories 421 to 423 are generated when the capability sections 411 to 413 access data items stored in the database 50. Note that the contents of the data item access histories 421 to 423 will be described below.

Furthermore, the production control system 40 is connected to the database 50. The database 50 stores data 51 accessed by the capability sections 411 to 413 of the production control system 40 for processing. The data 51 includes a plurality of data items (data items 1, 2, . . .). Additionally, the database 50 stores a DB access history 52 used as an access history controlled by the database 50. The contents of the DB access history 52 will be described below.

Note that the production control system 40 is connected to the network 32. The network 32 is desirably implemented by an intranet of a company operating the production control system 40. The network 32 is connected to terminal apparatuses that are not illustrated and that can communicate with the production control system 40. The terminal apparatuses display analysis results and instructions related to production that are provided by the production control system 40, and receive, from the user, inputs to the production control system 40.

Additionally, a file system 60 is connected to the network 32. The file system 60 stores a data item access history table 61 created from the data item access histories 421 to 423 and a DB access history table 62 created from the DB access history 52. The data item access history table 61 and the DB access history table 62 are generated by the production control system 40. Note that the contents of the data item access history table 61 and the DB access history table 62 will be described below.

Furthermore, the file system 60 more desirably stores a production control system management table 63 in which information related to the production control system 40 is recorded. The names of capabilities identifying the capabilities possessed at least by the production control system 40, functions for the capabilities, and the like are recorded in the production control system management table 63.

In this regard, in the present embodiment, the system building assisting apparatus 10 can be connected to the file system 60 via the network 31 and the network 32. In this case, in a case where the network 31 and the network 32 are intranets of different organizations, a wide area network such as the Internet is desirably provided between the networks 31 and 32. Additionally, in a case of being managed by the same organization, the system building assisting apparatus 10 and the production control system 40 may be connected via one network.

This configuration allows the system building assisting apparatus 10 to access the file system 60 and utilize the data item access history table 61 and the DB access history table 62. In this regard, in a case where the system building assisting apparatus 10 and the production control system 40 are managed by different organizations, access from the system building assisting apparatus 10 to the file system 60 may not be allowed. In this case, as illustrated in FIGS. 2A and 2B, the data item access history table 61 and the DB access history table 62 may be allowed to be utilized in the system building assisting apparatus 10 via a portable storage medium 70. Additionally, the storage medium 70 desirably also stores the production control system management table 63 like the file system 60.

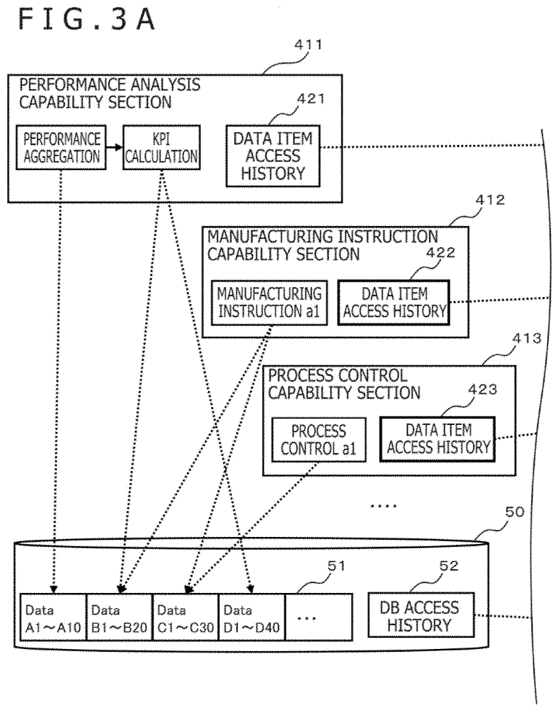

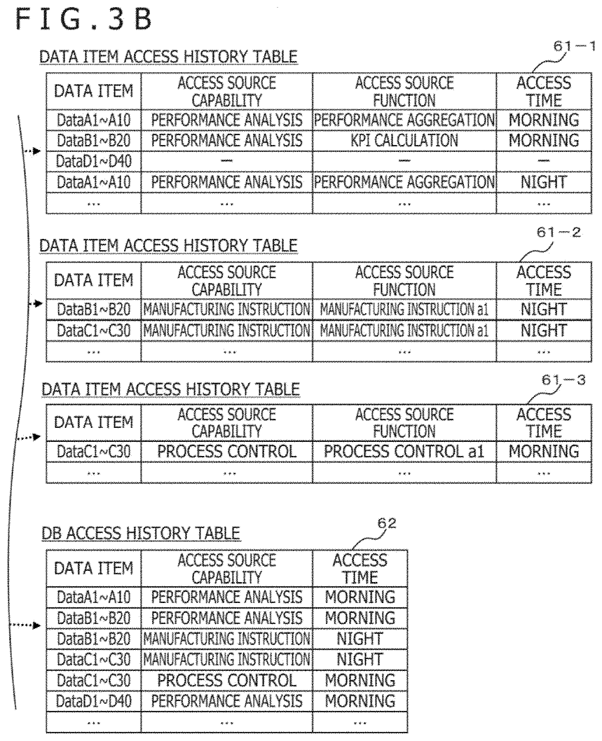

Now, the details of the processing of the present embodiment will be described using FIGS. 3A to 11. FIGS. 3A and 3B are a diagram for describing generation of various types of history information during operation of the production control system 40 that is required for the processing of the present embodiment. The history information includes the data item access histories 421 to 423 and the data item access history table 61, and the DB access history 52 and the DB access history table 62. FIGS. 3A and 3B illustrate the performance analysis capability section 411, the manufacture instruction capability section 412, and the process control capability section 413.

The performance analysis capability section 411 executes processing, according to functions such as KPI calculation for performance aggregation and production control. In using a function for performance aggregation, the performance analysis capability section 411 accesses the database 50. Specifically, the performance analysis capability section 411 accesses a data table including a data item “DataA1” to “DataA10” in data 51. Then, in using a function for KPI calculation on the basis of aggregated performance, the performance analysis capability section 411 accesses a data table constituting data items “DataB1 to B20” and “DataD1 to D40” in data 51. History indicating the access is recorded as data item access history 421 corresponding to a log, by the capability of an operation system (OS) of the production control system 40, the performance analysis capability section 411, a history creation capability section, or the like.

Then, the OS of the production control system 40 or the like create a data item access history table 61-1 for the performance analysis capability section 411 from the data item access history 421. In this regard, the processing of the OS of the production control system 40 or the like includes conversion of the data item access history 421, corresponding to text data in a csv file or in a JSON format, into the data item access history table 61-1, corresponding to data in a table form. Additionally, the data item access history table 61-1 is provided with the data items “DataA1 to A10,” “DataB1 to B20,” and “DataD1 to D40.” The data items illustrated in FIGS. 3A and 3B are in units of data tables, but may be in units of data items. Furthermore, the data item access history table 61-1 may have been sorted according to the data item or the like. These creation methods and structures also apply to the data item access history table 61-2, the data item access history table 61-3, and the DB access history table 62, described below.

Access source capabilities, access source functions, and access times are stored in association with the data items. In this regard, the access source capability is information identifying a capability having gained access (capability section) and indicates a candidate for a capability of a component system the building of which is assisted in the present embodiment. The access source function is information identifying a function used by the access source capability for access during the access. The access source function may be omitted. The access time is information indicating the time of access gained by the access source capability. In FIGS. 3A and 3B, the access time is indicated by information such as “morning” and “night.” However, the access time may be recorded in the format of year, month, day, and point of time (o′clock, minutes, and seconds).

Note that in the data item access history table 61-1 illustrated in FIGS. 3A and 3B, “−” is recorded for the data item “DataD1 to DataD40.” This indicates that the performance analysis capability section 411 has gained access but has not utilized the data item indicated by “DataD1 to D40.”

Then, the manufacture instruction capability section 412 executes a function for manufacture instruction al, and then accesses the data items “DataB1 to B20” and “DataC1 to C30” in the database 50. Then, the OS of the production control system 40 or the like records the data item access history 422. Then, the OS of the production control system 40 or the like creates a data item access history table 61-2 from the data item access history 422.

Likewise, the process control capability section 413 executes a function for process control al, and then accesses the data item “DataC1 to C30” in the database 50. Then, the OS of the production control system 40 or the like records the data item access history 423. In response, the OS of the production control system 40 or the like creates a data item access history table 61-3 from the data item access history 423. Note that the OS of the production control system 40 or the like may create a data item access history table 61 from the data item access history tables 61-1 to 61-3. Furthermore, the data item access history tables 61-1 to 61-3 may be treated as the data item access history table 61.

Moreover, on the database 50 side, the DB access history 52 is recorded in response to the above-described access. This is recorded by database management software, the OS of the production control system 40, or the like. Then, the database management software or the like creates a DB access history table 62 from the DB access history 52. In this case as well, the database management software or the like may convert the DB access history 52 in text format into DB access history table 62 in table format. Additionally, the database management software or the like may create the DB access history table 62 by sorting according to the data item.

As described above, during operation of the production control system 40, the data item access history table 61 and the DB access history table 62 are created. However, processing of the data item access history table 61 and the DB access history table 62 may be executed as processing of the system building assisting apparatus 10 described below.

Furthermore, for the production control system 40 operated for a certain period such as one year, the data item access history table 61 and the DB access history table 62 are desirably created. The period is suitably, for example, a production cycle for products or the like when all of the capabilities of the production control system 40 are executed. Such a period prevents accuracy from being reduced due to the lack of access to data items to be otherwise accessed.

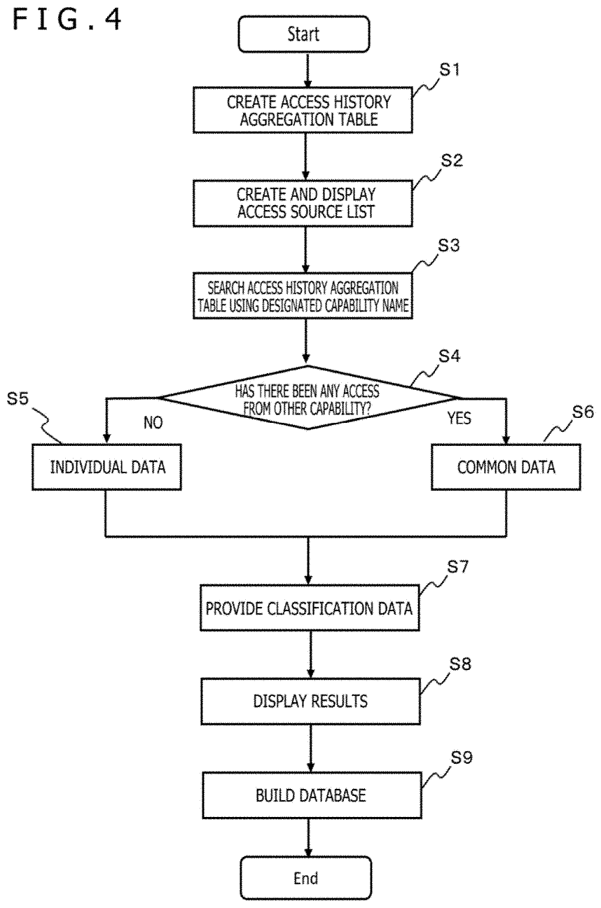

FIG. 4 is a flowchart illustrating the overall processing of the system building assisting apparatus 10 using the data item access history table 61 and the DB access history table 62.

The steps of the present flowchart are executed by the processing section 11, according to the access history aggregation table creation program 131 and the data classification program 132. For simplification of description, processing according to the access history aggregation table creation program 131 will be described on the assumption that the processing is mainly executed by an “access history aggregation table creation section 111.” Additionally, processing according to the data classification program 132 will be described on the assumption that the processing is mainly executed by a “data classification section 112.”

First, in step S1, the access history aggregation table creation section 111 creates an access history aggregation table 141 from the data item access history table 61 and the DB access history table 62. For this purpose, first, the access history aggregation table creation section 111 utilizes the communication I/F to read the data item access history table 61 and the DB access history table 62 from the file system 60 via the networks 31 and 32. At this time, the access history aggregation table creation section 111 may read the data item access history table 61 and the DB access history table 62 from the storage medium 70.

Then, the access history aggregation table creation section 111 merges the data item access history table 61 and the DB access history table 62 to create an access history aggregation table 141. Subsequently, the access history aggregation table creation section 111 stores the access history aggregation table 141 in the auxiliary storage apparatus 14. Note that the access of the present embodiment includes reference, read, and write but that any other operation may be included or any of these operations may be omitted.

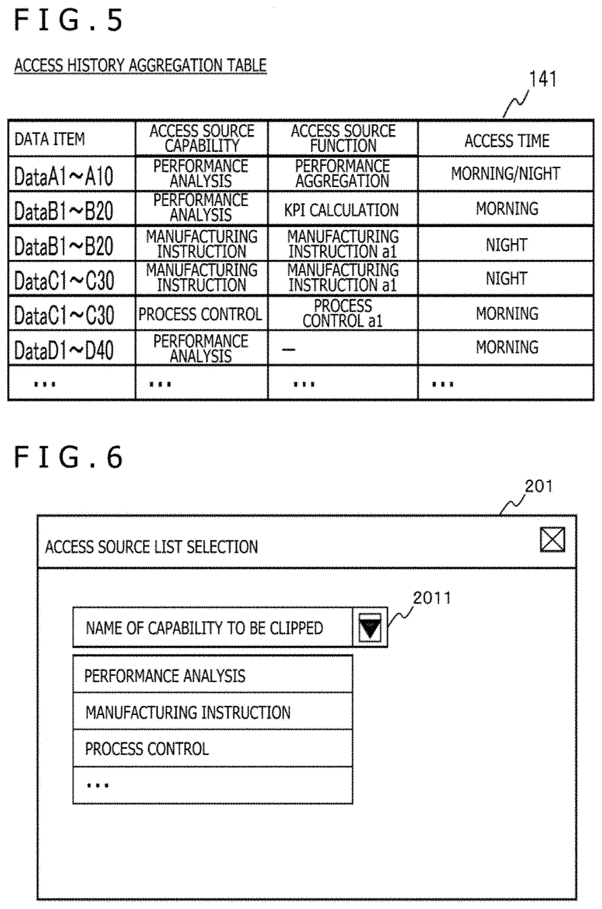

FIG. 5 illustrates the access history aggregation table 141. The access history aggregation table 141 includes the data item, the access source capability, the access source function, and the access time. These items correspond to the items in the data item access history table 61 and the DB access history table 62. Thus, the access source function may be omitted.

Here, the access history aggregation table creation section 111 compares records in the data item access history table 61 and the DB access history table 62 with one another and identifies matched records as one record in the access history aggregation table 141. Then, the access history aggregation table creation section 111 merges such records to create an access history aggregation table 141. In this regard, the access history aggregation table creation section 111 defines a case with no matched records also as one record in the access history aggregation table 141. This is to allow for a possible error when the data item access history table 61 or the DB access history table 62 is created or when any of the data item access histories 421 to 423 or the DB access history 52 is recorded.

Additionally, desirably, for records contained in the data item access history table 61 and the DB access history table 62 and having no match in access time, the access history aggregation table creation section 111 records the respective access times. This example is illustrated in the first record in FIG. 5. This enables a reduction in increase in the number of records, in other words, the amount of data in the access history aggregation table 141.

Note that the present embodiment uses the access history aggregation table 141 but can use access history information in which at least the access source capability and the data item are associated with each other. The access history aggregation table creation section 111 may use either the data item access history table 61 or the DB access history table 62 as access history information. Additionally, the access history aggregation table creation section 111 may create access history information including the access history aggregation table 141 using either the data item access history table 61 or the DB access history table 62. At this time, the creation is more desirably performed using the DB access history table 62.

Furthermore, in creating the access history aggregation table 141, the access history aggregation table creation section 111 may use data satisfying a predetermined condition. The predetermined condition includes the time or frequency of access to the data item access history table 61 and the DB access history table 62.

For example, the access history aggregation table creation section 111 excludes, from the data to be contained in the access history aggregation table 141, access to the data item access history table 61 or the DB access history table 62 which has been gained a predetermined certain period of time or earlier and fails to be confirmed. Additionally, the access history aggregation table creation section 111 excludes, from the data to be contained in the access history aggregation table 141, access to the data item access history table 61 or the DB access history table 62 which has been gained at a predetermined certain frequency or less or a predetermined certain number of times or less and fails to be confirmed. These predetermined conditions may be used in combination.

Furthermore, creation of the data item access history table 61 or the DB access history table 62 may similarly be performed using the predetermined condition.

Thus, in step S4 described below, access not satisfying the predetermined condition can be excluded. Furthermore, the access history aggregation table 141, the data item access history table 61, and the DB access history table 62 may be created without utilizing any predetermined condition, and the predetermined condition may be used during the determination in step S4. This will be described below in conjunction with the description of step S4.

Then, in step S2, the data classification section 112 creates an access source list. Then, the data classification section 112 uses the communication I/F to cause, via the network 31, the terminal apparatus 21 and the terminal apparatus 22 to display the list. FIG. 6 illustrates an example of a display screen 201 displaying the access source list. Note that the data classification section 112 creates the access source list using the production control system management table 63 stored in the file system 60 or the storage medium 70. In other words, the data classification section 112 lists the names of the capabilities of the production control system 40 recorded in the production control system management table 63.

As illustrated in FIG. 6, the users of the terminal apparatuses 21 and 22 can designate, by designation in a selection button 2011, the name of the capability to be clipped. In other words, the terminal apparatuses 21 and 22 receive the designation of the capability of the component system to be built. Then, the terminal apparatuses 21 and 22 notify the name of the capability selected to be clipped (capability) to the system building assisting apparatus 10 via the network 31. The name of the capability selected to be clipped is assumed to be “performance analysis” (performance analysis capability section 411).

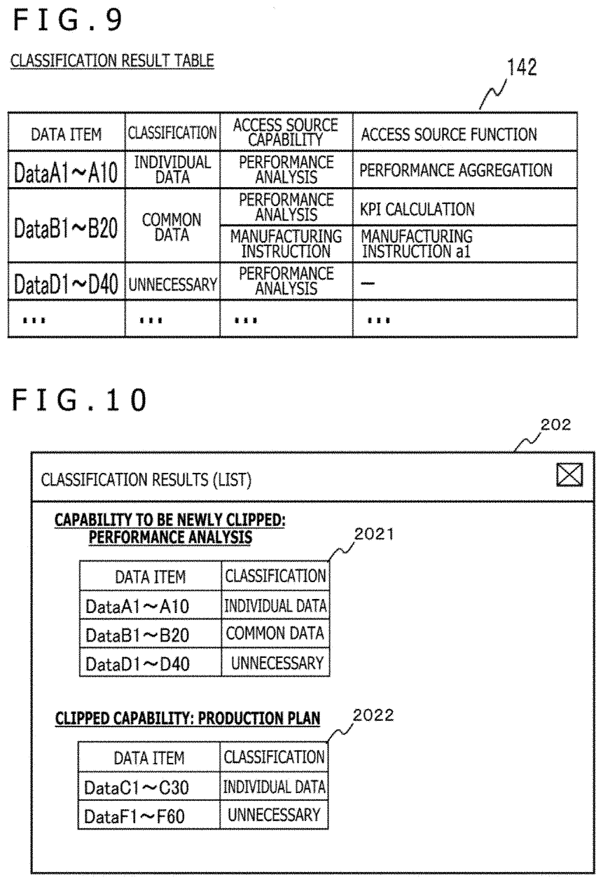

Note that in step S6, the data classification section 112 may case the terminal apparatuses 21 and 22 to display to the user a screen that is similar to the display screen illustrated in FIG. 6 and that is used to select the name of a clipped capability. In other words, the data classification section 112 receives, via the terminal apparatuses 21 and 22, the designation of the capability of the component system already identified. Thus, the data classification section 112 causes the selection button 2011 illustrated in FIG. 6 to be displayed such that “clipped” can be selected. To enable the “clipped” to be thus selected, the data classification section 112 uses the classification result table. The capabilities in the classification result table 142 illustrated in FIG. 9 for which the access source capabilities are recorded can be selected as “clipped.”

Thus, when results are displayed in step S8 described below, the data classification section 112 can cause the terminal apparatuses 21 and 22 to display the capability to be clipped and the clipped capability together. Note that the clipped capability may include “NO CLIPPED CAPABILITY.”

Then, in step S3, the data classification section 112 uses the name of the capability designated to be clipped, to search the access history aggregation table 141. In other words, the data classification section 112 searches the data items including “performance analysis” in the access source capability in the access history aggregation table 141. As a result, the data classification section 112 identifies the data items in the first record (data item name: DataA1 to A10), the second record (data item name: DataB1 to B20), and the sixth record (data item name: DataD1 to D40).

Then, in step S4, the data classification section 112 determines whether each of the data items identified in step S3 has been accessed from any other capability. In other words, the data classification section 112 checks whether any of the records in the access history aggregation table 141 having one of the data items DataA1 to A10, DataB1 to B20, and DataD1 to D40 has an access source capability other than “performance analysis.”

As a result, the data classification section 112 determines that none of the data items DataA1 to A10 and DataD1 to D40 are accessed from any other capability. Thus, for the data items DataA1 to A10 and DataD1 to D40, the processing proceeds to step S5. In other words, the data classification section 112 classifies the data items DataA1 to A10 and DataD1 to D40 as individual data regarding “performance analysis.”

Additionally, the data classification section 112 determines that the data item DataB1 to B20 has been accessed from another capability. Thus, for the data item DataB1 to B20, the processing proceeds to step S6. In other words, the data classification section 112 classifies the data item DataB1 to DataB20 as common data.

However, the data item D1 to D40 in the access history aggregation table 141 indicates “−” as the access source function. In other words, the data item D1 to D40 is not utilized in the performance analysis capability section 411. Thus, the data classification section 112 desirably classifies the data item D1 to D40 as unnecessary data. For this classification, the data classification section 112 uses the access source functions in the access history aggregation table 141. In other words, the data classification section 112 classifies data with the access source function indicating “−” as “unnecessary data” that is not to be classified.

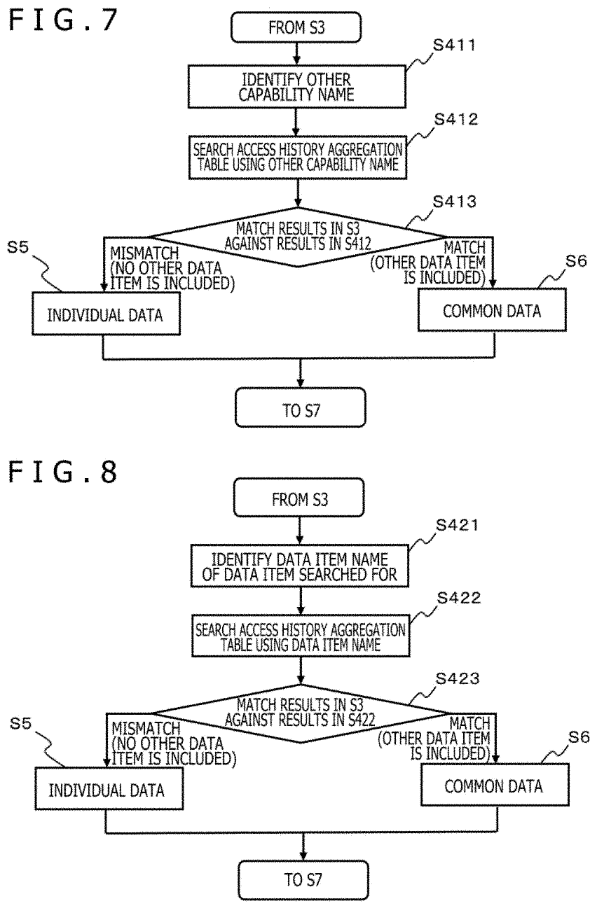

Now, two examples illustrating step S4 in detail will be described using FIG. 7 and FIG. 8. FIG. 7 is a flowchart illustrating a first example in the details of step S4. First, in step S411, the data classification section 112 identifies the names of the other capabilities, in other words, the names of the capabilities other than “performance analysis.” For this purpose, the data classification section 112 uses the production control system management table 63. The data classification section 112 identifies the names of the capabilities other than “performance analysis” from the production control system management table 63.

Then, in step S412, the data classification section 112 uses the names of the capabilities identified in step S411 to search the access history aggregation table 141. In other words, the data classification section 112 identifies the records in the access history aggregation table 141 indicating the names of the other capabilities as the access source capabilities. As a result, the data classification section 112 identifies the third record corresponding to the data item DataB1 to B20 and the fourth record corresponding to the data item DataC1 to C30, both records having “manufacture instruction.” as the access source capability. The data classification section 112 also identifies the fifth record corresponding to the data item DataC1 to C30 and having “process control” as the access source capability.

Then, in step S413, the data classification section 112 matches results in step S3 against results in step S412. In other words, the data classification section 112 compares the data item identified using “performance analysis” with the data item identified using the names of the capabilities other than “performance analysis.” As a result, for a data item determined to have no match, in other words, a data item specific to the data item identified using “performance analysis,” the processing proceeds to step S5. In this case, the data classification section 112 classifies the data items DataA1 to A10 and DataD1 to D40 as individual data regarding “performance analysis.” However, in the present embodiment, DataD1 to Data40 are not utilized in the production control system 40, and thus the data classification section 112 classifies the data item as “unnecessary data.”

Additionally, for a data item determined to have a match as a result of the comparison, in other words, a data item also included in the data item identified using the name of any of the capabilities other than “performance analysis,” the processing proceeds to step S6. In this case, the data item DataB1 to B20 are accessed by both “performance analysis” and “manufacture instruction,” and thus the data classification section 112 classifies the data item as common data.

FIG. 7, in other words, the first example in the details of step S4 has been described. Now, a second example in the details of step S4 will be described using FIG. 8. FIG. 8 is a flowchart illustrating the second example in the details of step S4. First, in step S421, the data classification section 112 identifies the names of the data items searched for in step S3. In other words, the data classification section 112 identifies the “data items” in the access history aggregation table 141 having “performance analysis” as the access source capability. In the example in FIG. 5, the data classification section 112 identifies the names of the data items DataA1 to A10, DataB1 to B20, and DataD1 to D40 as the names of the data items.

Then, in step S422, the data classification section 112 uses the name of the data items identified in step S421 to search the access history aggregation table 141. In other words, the data classification section 112 identifies the records indicating the data items DataA1 to A10, DataB1 to B20, and DataD1 to D40. As a result, the data classification section 112 identifies the data item DataA1 to A10 corresponding to the first record, the data item DataB1 to B20 corresponding to the second record, the data item DataB1 to B20 corresponding to the third record, and the data item DataD1 to D40 corresponding to the sixth record.

Then, in step S423, the data classification section 112 matches results in step S3 against results in step S412. In other words, the data classification section 112 compares each record (data item) identified using “performance analysis” with each record (data item) identified using the data item name indicated by this data item. As a result, for a data item having no match, in other words, a data item specific to the data item identified using “performance analysis,” the processing proceeds to step S5. In this case, the data classification section 112 classifies the data items DataA1 to A10 and DataD1 to D40 as individual data regarding “performance analysis.” However, in the present embodiment, DataD1 to Data40 is not utilized in the production control system 40, and thus the data classification section 112 classifies this data item as “unnecessary data” as described above.

Additionally, for a data item determined to have a match as a result of the comparison, in other words, a data item also included in the record (data item) identified using the data item name, the processing proceeds to step S6. In this case, the data item DataB1 to B20 is accessed by both “performance analysis” and “manufacture instruction,” and thus the data classification section 112 classifies this data item as common data.

Note that in step S4, the data classification section 112 may use the above-described predetermined condition data to determine whether the record has been accessed by any of the other capabilities. In other words, even in a case where access from another capability is recorded in the access history aggregation table 141, the data classification section 112 determines that there has been no access in a case where the access does not satisfy the predetermined condition. The predetermined condition includes at least one of the frequency of access, the number of times of access, and the time of access.

The usage of the predetermined condition also applies to determination processing in FIG. 7 and FIG. 8. In other words, the data classification section 112 performs the search in step S412 or performs, in step S413, the search or determination of comparison results using the predetermined condition. In particular, in step S413, even in a case where a match is found between data items, the data classification section 112 determines a mismatch in a case where at least one of the matched data items does not satisfy the predetermined condition.

Additionally, the data classification section 112 performs the search in step S422 or also performs, in step S423, the search or determination of comparison results using the predetermined condition. In particular, in step S423, even in a case where a match is found between data items, the data classification section 112 determines a mismatch in a case where at least one of the matched data items does not satisfy the predetermined condition.

The details of step S4 have been described and steps S5 and S6 have been described. Now, with reference back to FIG. 4, processing in step S7 and subsequent steps will be described.

In step S7, the data classification section 112 records, in the classification result table 142, results of the classification in step S5 and step S6. FIG. 9 illustrates the contents of the classification result table 142. The classification result table 142 includes the data items, the results of the classification in steps S5 and S6, the access source capabilities, and the access source functions. Among these data, the access source functions may be omitted. Additionally, DataB1 to B20 classified as common data is associated with all of “performance analysis” and “manufacture instruction” corresponding to the names of the capabilities sharing the present data item and “KPI calculation” and “manufacture instruction al” used by “performance analysis” and “manufacture instruction.”

Additionally, the data classification section 112 may record the results of processing of the data classification section 112 in the access history aggregation table 141. In other words, the data classification section 112 uses the classification results in step S5 to record the corresponding records in the access history aggregation table 141 as “individual data.” In addition, the data classification section 112 uses the classification results in step S6 to record the corresponding records in the access history aggregation table 141 as “common data.”

Note that provision of the classification result table 142 or access history aggregation table 141 as described above enables the data classification section 112 to exclude, when the subsequent capability is clipped, the recorded data from search targets, reducing the records to be searched. Thus, the data classification section 112 may record information subjected to determination and classification of data, instead of the “individual data” and “common data.”

Then, in step S8, the data classification section 112 uses the communication I/F to cause, via the network 31, the terminal apparatus 21 or the terminal apparatus 22 to display the classification results. It is sufficient that the classification results can indicate to which classification the data item belongs. FIG. 10 illustrates an example of a display screen 202 displaying the classification results in a list. As illustrated in FIG. 10, the data classification section 112 causes classification results 2021 for the “capability to be newly clipped” and classification results 2022 for the “clipped capability” to be displayed such that the data items are associated with the classification results. At this time, the data classification section 112 may cause classification results 2021 for the “capability to be newly clipped” and classification results 2022 for the “clipped capability” to be selectively displayed.

Furthermore, the data classification section 112 may include, in the list, the access source function having accessed the data item. Additionally, although not illustrated, the data classification section 112 may cause capabilities not clipped yet to be also displayed on the display screen 202. Note that the display screen 202 may collectively express, in one table or the like, the classification results 2021 for the “capability to be newly clipped” and the classification results 2022 for the “clipped capability.”

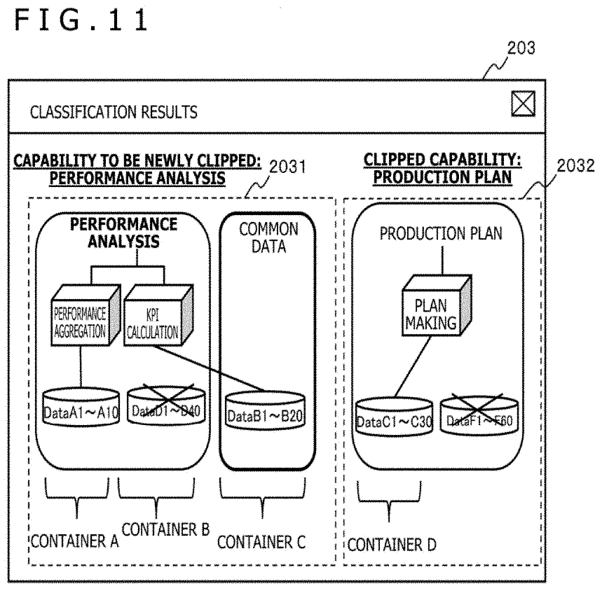

Furthermore, in step S8, the data classification section 112 may cause the classification results to be graphically displayed. FIG. 11 illustrates an example of a display screen 203. As illustrated in FIG. 11, the data classification section 112 causes classification results 2031 for the “capability to be newly clipped” and classification results 2032 for the “clipped capability” to be graphically displayed in association with the respective capabilities, access source functions, and data items. First, in the classification results 2031 for the “capability to be newly clipped,” performance aggregation and KPI calculation are present as access source functions for performance analysis. The figure illustrates that the performance aggregation has accessed DataA1 to A10 as individual data. Additionally, DataD1 to D40 is crossed to indicate that the data is unnecessary. Furthermore, the figure illustrates that DataB1 to B20 is common data.

Additionally, in the classification results 2032 for the “clipped capability,” plan making is present as an access source function for production plan corresponding to a clipped capability. The figure illustrates that the plan making has accessed DataC1 to C30 as individual data. In addition, DataF1 to F640 is crossed to indicate that the data is unnecessary.

Note that the data classification section 112 may cause the classification results 2031 for the “capability to be newly clipped” and the classification results 2032 for the “clipped capability” to be displayed together instead of being separately displayed. Furthermore, the data classification section 112 causes containers, in other words, components of a component system to be built to be displayed on the display screen 203.

Then, in step S9, the data classification section 112 executes processing for building a database. The processing includes the data classification section 112 utilizing the communication I/F to transmit the classification result table 142 to the file system 60 via the network 31 and 32. Then, the terminal apparatus connected to the network 32 can be utilized to read, from the database 50, the data items specified in the classification result table 142 and build a database adapted to the component system to be built. The processing in the flowchart illustrated in FIG. 4 ends. However, the present step may be omitted and the processing may be ended in step S8.

In the present embodiment described above, in step S2, the designation of the capability to be clipped is received. In this regard, a plurality of names of capabilities may be designated or the designation may be omitted. In the latter case, the processing of the present embodiment is desirably executed, at the same time, on the capabilities recorded in the access history information represented by the access history aggregation table 141. In other words, the processing of the present embodiment is executed on the capabilities included in a monolithic system such as the production control system 40.

Furthermore, in the present embodiment, the data item access histories 421 to 423 and the DB access history 52 are collected by the OS of the production control system 40 or the management apparatus for the database 50. However, for this collection capability, a collection capability section may be added to the production control system 40 to execute the capability.

1. A system building assisting apparatus for building a component system on a basis of an integrated system including a plurality of capabilities and a shared database shared by the plurality of capabilities and including a plurality of data items, the system building assisting apparatus comprising:
a storage apparatus storing access history information indicating that any of the data items constituting the shared database has been accessed by an access source capability of the integrated system, the access history information associating the access source capability and the data item corresponding to an access destination; and
a processing section
searching the access history information using a first capability name identifying a first capability included in the component system, to identify a data item for which the first capability corresponds to an access source,
using the access history information to determine whether the data item identified has been accessed by a second capability included in the plurality of capabilities, and
in a case of determining that the data item has not been accessed by the second capability, determining that the data item identified is individual data for the first capability.

2. The system building assisting apparatus according to claim 1, wherein
the processing section
uses a second capability name identifying the second function to search the access history information for data items, and
determines, among the data items searched for using the first capability name, data items not included in the data items searched for using the second capability name to be individual data.

3. The system building assisting apparatus according to claim 1, wherein
the processing section
uses a data item name identifying the data item identified to search the access history aggregation table for a capability name identifying a capability name corresponding to an access source for the data item, and
determines the data item for which the capability name searched for is the first capability name to be the individual data.

4. The system building assisting apparatus according to claim 1, wherein
the processing unit determines that the second function has gained no access in a case where, for the data item identified from the second function, no access satisfying a predetermined condition is recorded in the access history information.

5. The system building assisting apparatus according to claim 4, wherein
the processing section uses, as the predetermined condition, at least one of presence of access within a preset period, the number of times of access, and an access frequency.

6. A system building assisting method using a system building assisting apparatus for building a component system on a basis of an integrated system including a plurality of capabilities and a shared database shared by the plurality of capabilities and including a plurality of data items, the system building assisting method comprising:
storing, in a storage apparatus of the system building assisting apparatus, access history information indicating that any of the data items constituting the shared database has been accessed by an access source capability of the integrated system, the access history information associating the access source capability and the data item corresponding to an access destination; and
by a processing section of the system building assisting apparatus,
searching the access history information using a first capability name identifying a first capability included in the component system, to identify a data item for which the first capability corresponds to an access source,
using the access history information to determine whether the data item identified has been accessed by a second capability included in the plurality of capabilities, and
in a case of determining that the data item has not been accessed by the second capability, determining that the data item identified is individual data for the first capability.

7. The system building assisting method according to claim 6, wherein
the processing section
uses a second capability name identifying the second function to search the access history information for data items, and
determines, among the data items searched for using the first capability name, data items not included in the data items searched for using the second capability name to be individual data.

8. The system building assisting method according to claim 6, wherein
the processing section
uses a data item name identifying the data item identified to search the access history aggregation table for a capability name identifying a capability name corresponding to an access source for the data item, and
determines the data item for which the capability name searched for is the first capability name to be the individual data.

9. The system building assisting method according to claim 6, wherein
the processing unit determines that the second function has gained no access in a case where, for the data item identified from the second function, no access satisfying a predetermined condition is recorded in the access history information.

10. The system building assisting method according to claim 9, wherein
the processing section uses, as the predetermined condition, at least one of presence of access within a preset period, the number of times of access, and an access frequency.
